(19) United States
(12) Patent Application Publication
(10) Pub. No.: US 2026/0236841 A1
(43) Pub. Date: Aug. 13, 2026

(54) System and Method for Creating, Securely Training, and Bequeathing an Interactive Digital Personality via a Wearable Data Acquisition Device and Software Platform.

(71) Applicants: Rodion Sorokin, Fort Lauderdale, FL (US); Serhii Nikolaichuk, Austin, TX (US)

(72) Inventors: Rodion Sorokin, Fort Lauderdale, FL (US); Serhii Nikolaichuk, Austin, TX (US)

(21) Appl. No.: 19/319,614

(22) Filed: Sep. 4, 2025

(51) Int. Cl. G06N 20/00; G06F 3/01; G10L 15/18

(52) U.S. Cl. CPC G06N 20/00; G06F 3/011; G10L 15/1807

(57) ABSTRACT

A system for creating an interactive digital personality is disclosed. The system comprises a wearable device with biometric and audio sensors for passive data collection, wherein audio is processed locally to ensure privacy. A software platform transforms this multimodal data into a unified mathematical “personality vector.” A secure incremental learning core updates a personality model using a federated learning method, where only anonymized model updates are transmitted from a user's device. A generative engine uses the model to produce responses in the creator's style. Finally, a digital inheritance module utilizes a smart contract on a distributed ledger to manage access based on predefined, verifiable rules. This invention provides an end-to-end, privacy-preserving ecosystem for creating, training, and bequeathing a digital personality, and serves as a research platform for computational personality science.

### CROSS-REFERENCE TO RELATED APPLICATIONS

This application claims the benefit of U.S. Provisional Application No. 63/864,239, filed on Aug. 14, 2025, the entire disclosure of which is hereby incorporated by reference.

### BACKGROUND OF THE INVENTION

The present disclosure relates generally to the field of digital data processing and, more specifically, to systems utilizing artificial intelligence and machine learning for creating personalized digital models. The invention concerns a comprehensive ecosystem for the aggregation and analysis of personal data, the continuous training of generative models, and the provision of controlled access to interactive digital avatars, particularly within a framework of digital inheritance.

Existing technologies for preserving an individual's legacy are fragmented and limited. Cloud storage systems serve as passive archives. Conversational AI agents can simulate dialogue but fail to capture an authentic personality. Voice cloning technologies can reproduce a person's voice but not the substance of their thoughts. Digital legacy services are typically limited to transferring access to online accounts or preserving static data.

A primary deficiency in the prior art is the lack of a unified, interactive system that can securely and privately learn from a user's life experiences over time. Current AI training methodologies often pose significant privacy risks. Furthermore, a legally and technologically robust mechanism for bequeathing an interactive digital entity does not exist. Therefore, a need exists for an integrated system that overcomes these limitations.

### SUMMARY OF THE INVENTION

The objective of the present invention is to provide a unified ecosystem, hereinafter referred to as “AI Time Capsule™,” which enables a user to create an interactive digital representation of themselves (a “digital personality”), train it throughout their life in a secure and private manner, and define the terms of its inheritance. This is achieved by a system comprising a wearable data acquisition device and a software platform that includes a multimodal data ingestion subsystem, a secure incremental learning core based on federated learning, a generative personality engine, and a digital inheritance management module based on distributed ledger technology. The invention transforms disparate personal data into a living, interactive avatar capable of meaningful dialogue based on the creator's life experience and values.

### BRIEF DESCRIPTION OF THE DRAWINGS

The accompanying drawings, which are incorporated in and constitute a part of this specification, illustrate embodiments of the invention and, together with the description, serve to explain the principles of the invention.

FIG. 1 is a block diagram illustrating the overall system architecture of the AI Time Capsule™ ecosystem.

FIG. 2 is a flowchart illustrating the data flow process for the secure, incremental update of the core Personality Vector.

FIG. 3 is a flowchart illustrating the logic of the Digital Inheritance Module.

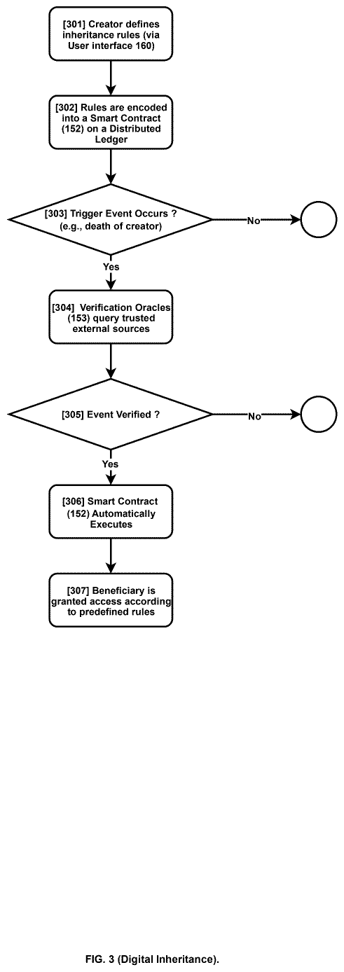

FIG. 4 is a block diagram illustrating an alternative embodiment of the user interaction layer, configured for use with a Virtual Reality (VR) or Augmented Reality (AR) interface.

### DETAILED DESCRIPTION OF THE INVENTION

Reference will now be made in detail to the preferred embodiments of the invention. The present invention introduces a novel form of Computational Personality Science, operationalized via privacy-preserving federated architectures. The system's ethical framework is designed to align with institutional standards such as the NIST AI Risk Management Framework (RMF) and the Belmont Report.

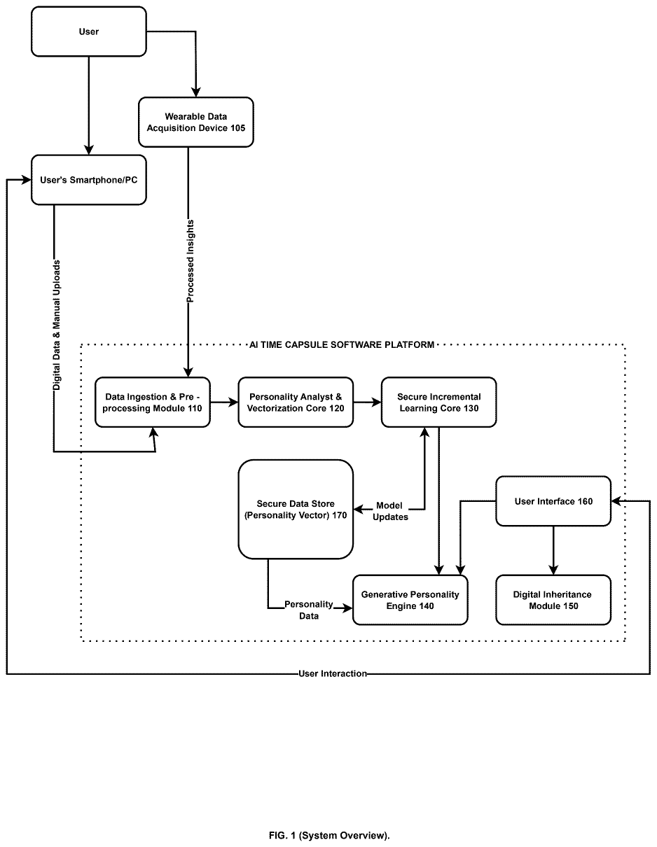

As depicted in FIG. 1, the system (100) comprises a Wearable Data Acquisition Device (105) and an AI Capsule™ Software Platform.

The Wearable Data Acquisition Device (105) is configured for passive, continuous data collection and may include a variety of sensors. In one embodiment, it includes biometric sensors such as a photoplethysmography (PPG) sensor and an electrodermal activity (EDA) sensor, configured with a sampling rate between 50-200 Hz. It may also include a camera for capturing visual context, an accelerometer for activity tracking, and a GPS module for location data. The device's Audio Subsystem (106) utilizes a low-power processor to extract prosodic speech characteristics and immediately discards the raw audio to ensure privacy. The processor may comprise an ARM Cortex-M series microcontroller with a low-power DSP core to facilitate efficient on-device processing.

The Data Ingestion Module (110) receives data from the device (105) and is configured with API connectors for secure integration with platforms such as Apple's HealthKit and Google's Health Connect.

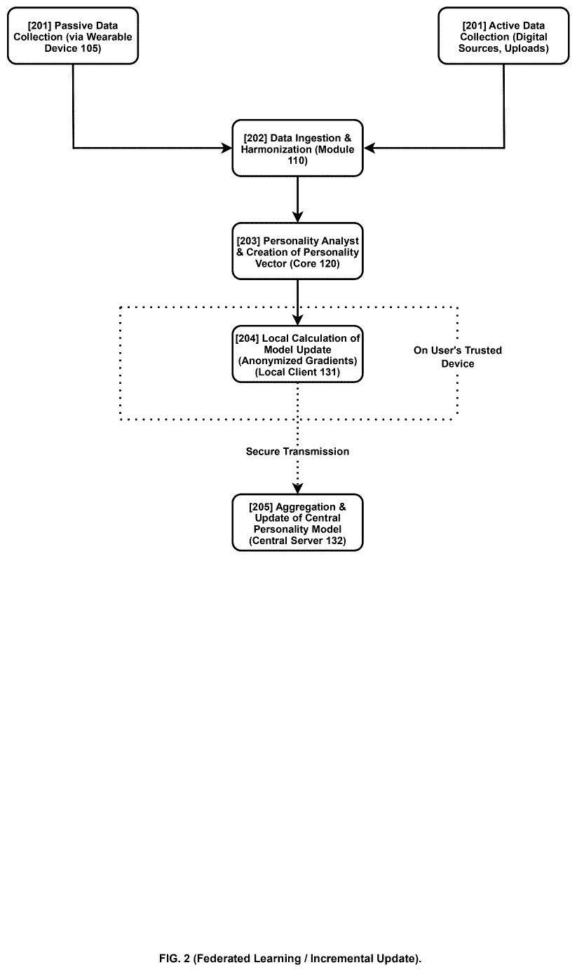

The Secure Incremental Learning Core (130) implements a federated learning method as illustrated in FIG. 2. A Local Training Client (131) computes anonymized model gradients. Technical parameters for this process may include batch sizes of 32 to 128 samples, with update frequencies ranging from once per day to once per week. Data transmission utilizes secure protocols such as TLS 1.3. The personality vector may be structured as a high-dimensional embedding with a size of 1024 or greater, using a float16 data type for efficient storage and computation.

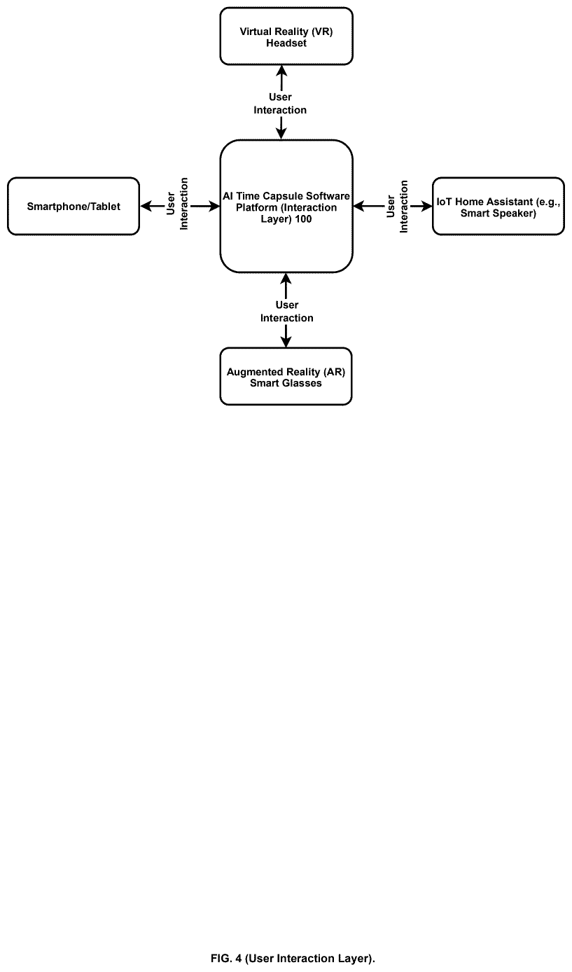

Further Embodiments, Best Mode, and Use Cases: As illustrated in the alternative embodiment of FIG. 4, the system is not limited to a smartphone interface and may include interfaces for Virtual Reality (VR), Augmented Reality (AR) platforms, smart glasses, and Internet of Things (IoT) home assistants. In a preferred “best mode” implementation, the cloud-based components may utilize a serverless architecture, such as AWS Lambda and Amazon DynamoDB, for maximum scalability. Potential applications are broad:
Grief Therapy: The system provides a controlled therapeutic tool, allowing a user to engage in dialogues with a loved one's persona to process grief. Interaction rules, defined in the smart contract, can limit session frequency or duration to prevent unhealthy dependency, aligning with clinical best practices.
Corporate Knowledge Continuity (Enterprise Embodiment): An avatar of a key executive or engineer can be created to preserve critical institutional knowledge. Upon the employee's departure, a “corporate transfer of rights” event can trigger the smart contract, granting access to designated successors for training and consultation. This provides a dynamic, interactive knowledge management tool that goes far beyond static documentation.
Digital Humanities & Education: The system enables the creation of interactive archives of historical figures, allowing students and researchers to engage in dialogue with simulated personalities, providing a new medium for immersive learning and research.”

### INDUSTRIAL APPLICABILITY

The invention has wide industrial applicability. In the commercial sector, it creates a new market for digital legacy. In the medical and healthcare sector, it provides a platform for novel therapeutic interventions, with a system architecture designed to be compliant with standards like HIPAA for data privacy. In the educational sector, it enables new forms of immersive learning and can be aligned with accreditation standards for digital archives. In the enterprise sector, its application for knowledge retention supports compliance with standards such as ISO 30401 (Knowledge Management Systems). The system's scalable, cloud-native architecture is designed for robust deployment in all these fields.

### ADVANTAGES OVER PRIOR ART

The present invention overcomes the limitations of the prior art in several key ways. Unlike passive storage systems (e.g., iCloud), it provides for dynamic, generative interaction. Unlike generic conversational agents (e.g., Replika), it is trained on holistic, multimodal personal data, ensuring a truly authentic personality simulation. Unlike simple voice cloning, it captures the substance of thought and reasoning. Finally, unlike existing digital legacy services, it provides a technologically robust and legally binding mechanism for inheritance through its novel use of smart contracts and distributed ledger technology.

While the invention has been described in connection with specific embodiments, it will be understood by those skilled in the art that numerous modifications and variations may be made without departing from the scope of the invention as defined by the appended claims.

What is claimed is:

1. A system for creating and managing an interactive digital personality, the system comprising:
a wearable device comprising at least one biometric sensor and a processor configured to locally process audio data to extract speech characteristics without transmitting raw audio;
a software platform comprising a memory and at least one hardware processor, said platform configured to:
receive said speech characteristics and data from said at least one biometric sensor;
transform said received data into a unified mathematical personality vector;
update a personality model based on said personality vector using a federated learning method;
utilize said personality model to generate responses to user queries;
manage access to said digital personality via a digital inheritance module that utilizes a smart contract on a distributed ledger.

2. The system of claim 1, wherein the at least one biometric sensor is selected from the group consisting of a photoplethysmography (PPG) sensor, an electrodermal activity (EDA) sensor, a camera, an accelerometer, and a GPS module.

3. The system of claim 1, wherein the software platform is further configured to receive data via an API from a health data service selected from the group consisting of Apple HealthKit and Google Health Connect.

4. The system of claim 1, wherein the personality model is updated using a parameter-efficient fine-tuning (PEFT) technique.

5. The system of claim 4, wherein the PEFT technique is Low-Rank Adaptation (LoRA).

6. The system of claim 1, wherein the smart contract is configured to execute automatically upon a verifiable event confirmed by a verification oracle, said event selected from the group consisting of the creator's death, a legal incapacitation, and a corporate transfer of rights.

7. The system of claim 1, further comprising a user interface configured for a device selected from the group consisting of a virtual reality device, an augmented reality device, smart glasses, and an IoT home assistant.

8. A method for creating and managing an interactive digital personality, comprising the steps of:
collecting multimodal data via a wearable device;
analyzing said multimodal data to form a unified mathematical personality vector;
securely updating a personality model based on said personality vector using a federated learning protocol;
receiving a query from a user;
generating a response to said query using the updated personality model; and
executing a smart contract on a distributed ledger to grant access to the digital personality upon verification of a predefined trigger event.

9. The method of claim 8, wherein the predefined trigger event is a corporate transfer of rights for a digital personality created for institutional knowledge preservation.

10. A non-transitory computer-readable medium having instructions stored thereon, that when executed by a processor, cause the processor to perform the method of claim 8.

11. A wearable data acquisition device, comprising:
at least one biometric sensor;
an audio sensor;
a processor comprising a low-power digital signal processing (DSP) core; and
a memory storing instructions that, when executed by the processor, cause the device to:
capture audio data via the audio sensor;
process said audio data locally on the device to extract prosodic speech characteristics;
discard the captured audio data after processing;
transmit said prosodic speech characteristics and data from the at least one biometric sensor to an external software platform.
